(19) United States
(12) Patent Application Publication
(10) Pub. No.: US 2013/0304768 A1
(43) Pub. Date: Nov. 14, 2013

(54) Advancements in Systems and Methods for Quickly and Transparently Provisioning, Horizontal Sealing, and Managing of Databases in a Cloud Environment

(71) Applicants: Michael Basnight, Austin, TX (US); Keith Bray, Austin, TX (US); Daniel Morris, Austin, TX (US); Chris Sackman, San Antonio, TX (US)

(72) Inventors: Michael Basnight, Austin, TX (US); Keith Bray, Austin, TX (US); Daniel Morris, Austin, TX (US); Chris Sackman, San Antonio, TX (US)

(21) Appl. No.: 13/467,579

(22) Filed: May 9, 2012

(51) Int. Cl. G06F 17/30

(52) U.S. Cl. 707/802; 707/E17.005

(57) ABSTRACT

Systems and methods directed generally to advancements for quickly and transparently provisioning, horizontal scaling, and managing of databases, and more specifically to a system and method for quickly and transparently provisioning, horizontally scaling and managing MS SQL databases in a cloud environment. This method also includes certain optimization and rebalancing innovations to maximize database performances.

### BACKGROUND OF THE INVENTION

1. Field of the Invention

The present invention is directed generally to advancements in systems and methods for quickly and transparently provisioning, horizontal scaling, and managing of databases, and more specifically to a system and method for quickly and transparently provisioning, horizontally scaling and managing MS SQL databases in a cloud environment.

2. Description of Related Art

Computer-based databases permeate the modern economy. Entities of all sizes from governments to nearly every kind of business use databases as an integral part of their activities. In addition, more and more individuals and small groups are using databases for managing their activities from clubs, to churches, to personal data.

Currently, the creation and management of a relational database system requires intensive and costly investments in datacenter facilities or database servers. This process requires costly hardware and software. Furthermore, to build and provision an enterprise level database requires expensive personnel and facilities to plan and implement the relational database system. Once the database has been created further personnel are required to manage and maintain the database. Therefore current art requires a long lead time to manage their database server needs due to these expenses. There is a long felt need in the art for a system and method of quickly and transparently provisioning, horizontal scaling, and managing of databases.

### SUMMARY OF THE INVENTION

The present invention is directed to a system and method of quickly provisioning, horizontally scaling, and managing of databases. The invention includes methods to integrate database servers into a cloud environment that otherwise are not natively compatible in an environment. The disclosed and needed invention also describes innovations to enable the efficient horizontal scaling and rebalancing of database from the individual database within a single server level on to and across multiple servers in a database cluster level. One embodiment of this invention envisions the methods and systems using the commercially available database software package MS SQL and the cloud infrastructure as a service environment OpenStack Nova.

Many other objects, features, advantages, benefits, improvements and non-obvious unique aspects of the present invention and of its present embodiments, as well as the prior problems, obstacles, limitations and challenges that are addressed, will be evident to the reader who is skilled in the art, particularly when this application is considered in light of the prior art. It is intended that such objects, features, advantages, benefits, improvements and non-obvious unique aspects are within the scope of the present invention, the scope of which is limited only by the claims of this and any related patent applications and any amendments thereto.

### BRIEF DESCRIPTION OF THE DRAWINGS

To the accomplishment of all the above, it should be recognized that this invention may be embodied in the form illustrated in the accompanying drawings, attention being called to the fact, however, that the drawings are illustrative only, and that changes may be made in the specifics illustrated or described.

FIG. 1 is a high-level view of major components of a typical preferred embodiment of the present invention deployed using MS SQL as the core database software;

FIG. 2 is a detailed flow diagram of a typical preferred embodiment of the present invention the diagram which continues with FIG. 3;

FIG. 3 is a continuation of the process set forth in FIG. 2 and is a detailed flow diagram of a typical preferred embodiment of the present invention; and

FIG. 4 is an internal detailed flow diagram of Database Server and Optimization System 500 showing innovations implemented by the present invention.

### DETAILED DESCRIPTION OF PREFERRED EMBODIMENT

As previously stated, the present invention is directed to a system and method for quickly provisioning, horizontal scaling, and management of databases. The system includes a method to integrate relational database servers into a cloud environment that otherwise are not natively compatible in an environment. The system also describes innovations to enable the efficient horizontal scaling and rebalancing of a database from the individual database server within a single server level up to the database server cluster level. One embodiment of this invention envisions the methods and systems using the commercially available database software package MS SQL and the cloud infrastructure as a service environment OpenStack Nova. This is accomplished by introducing various components that act as interfaces between otherwise incompatible software products. Furthermore, various optimization components are described below.

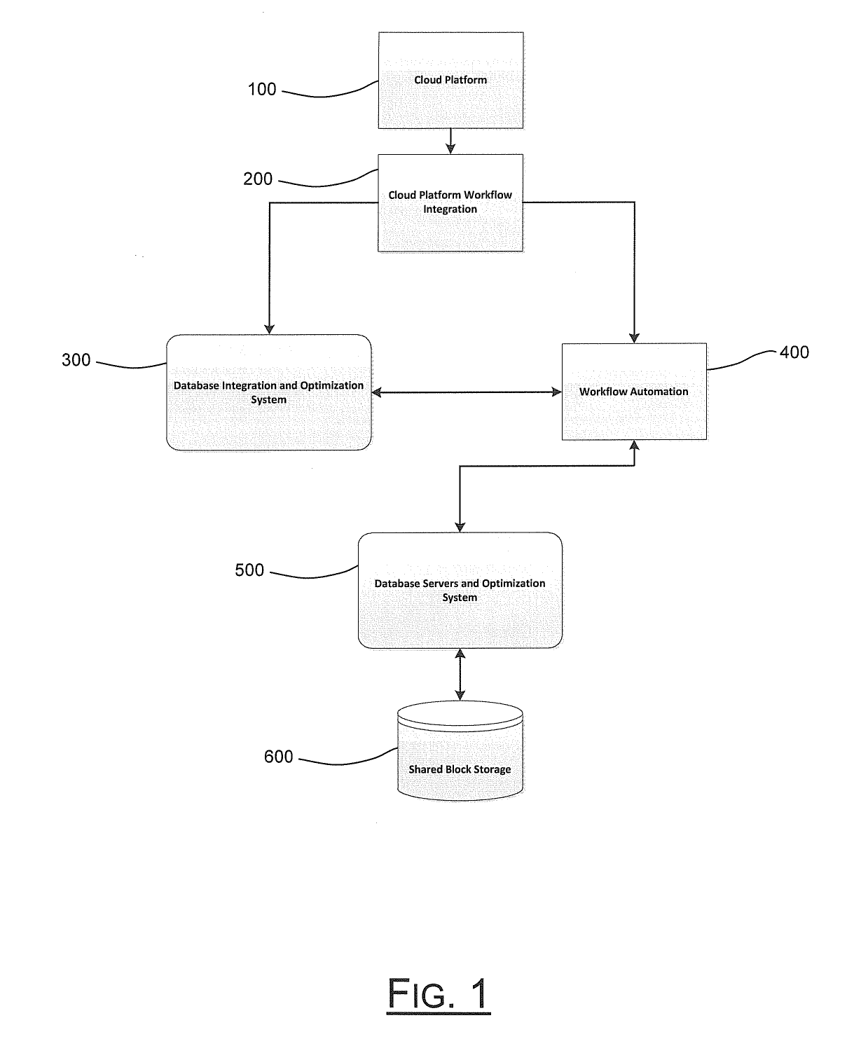

Turning to FIG. 1, which shows a high level view of a typical preferred embodiment of the present invention the Database Integration and Optimization System 300 and the Database Servers and Optimization System 500 along with its major supporting components. Specifically, cloud platform 100 controls the Infrastructure as a Service (IaaS) cloud computing platform. The cloud platform 100 systems define drivers that interact with the underlying virtualization mechanisms of hardware computer systems. The cloud platform 100 systems are typically implemented in a datacenter on clusters of real or virtual servers. The cloud platform 100 allows the automatic provisioning of computer instances, network connections, and storage by request of the user. One embodiment of cloud platform 100 capitalizes on the OpenStack Nova software product (referred to as the “OpenStack Nova” for purposes of this description), which is commercially available in the United States as of the filing date of this description.

The cloud platform 100 interfaces with the cloud platform workflow integration 200. This is a pack of services that translates the instructions between the cloud platform 100 and the Database Integration and Optimization System 300 as further described below. The cloud platform 100 also interfaces with the workflow automation 400.

The workflow automation 400 is similar to various commercially available in the United States as of the filing date of the present application and is more fully described below. In the present embodiment the workflow automation 400 is a proprietary to Microsoft software program called System Center Orchestrator that does not interface with many cloud based IaaS solutions. The present invention allows the use and integration of the workflow automation 400 as well as MS SQL with a wide variety of IaaS solutions, thus filling a long felt need in the art.

The workflow automation 400 interfaces with the Database Servers and Optimization System 500, which provides the core database functionality as well as incorporates innovations in the management and resource optimization of the databases as more fully described below. The final major component of the present invention is the shared block storage 600, which provides scalable storage utilized by the Database Servers and Optimization System 500.

In some embodiments of the present invention, the method and systems described in FIG. 1 are provided via computer software, either via the interne, via a stand-alone software application operating independently or in connection with other software systems, or some combination of the two. As well, embodiments may come in any known form and may also be implemented by hardware, software, scripting languages, firmware, middleware, microcode, hardware description languages, and/or any combination thereof. When implemented with coded programming, it should also be understood that the program code or code segments to perform the necessary steps or tasks of alternative embodiments may be coded in solid state or may be stored in a machine-readable medium such as a computer storage medium. A code segment or machine-executable step or instruction may represent a procedure, a function, a subprogram, a program, a routine, a subroutine, a module, a software package, a script, a class, or any combination of instructions, data structures, and/or program statements. Executable code segments may also be coupled to other code segments or to a hardware circuit by passing and/or receiving information, data, arguments, parameters, and/or memory contents, which may be passed, forwarded, or transmitted via any suitable means including memory sharing, message passing, token passing, network transmission, etc.

With reference again to FIG. 1, the preferred embodiment of the disclosed invention, specifically the Database Integration and Optimization System 300 and the Database Servers and Optimization System 500 is provided in the form of software that is installed and adapted to interact with the databases, servers and ten finals of a data management system, or in this embodiment the cloud platform 100, the cloud platform workflow integration 200, the workflow automation 400, and the shared block storage 600 systems. It should be understood that the graphical representation of the system is an exemplary reference to any number of software systems that may be implemented by the present invention.

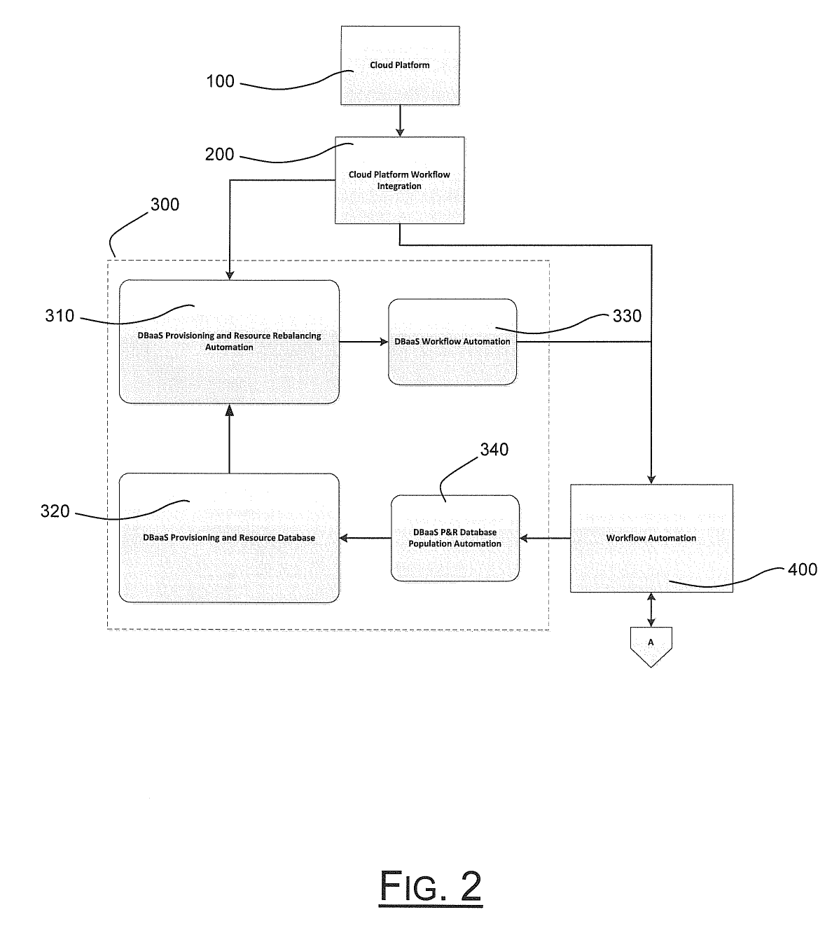

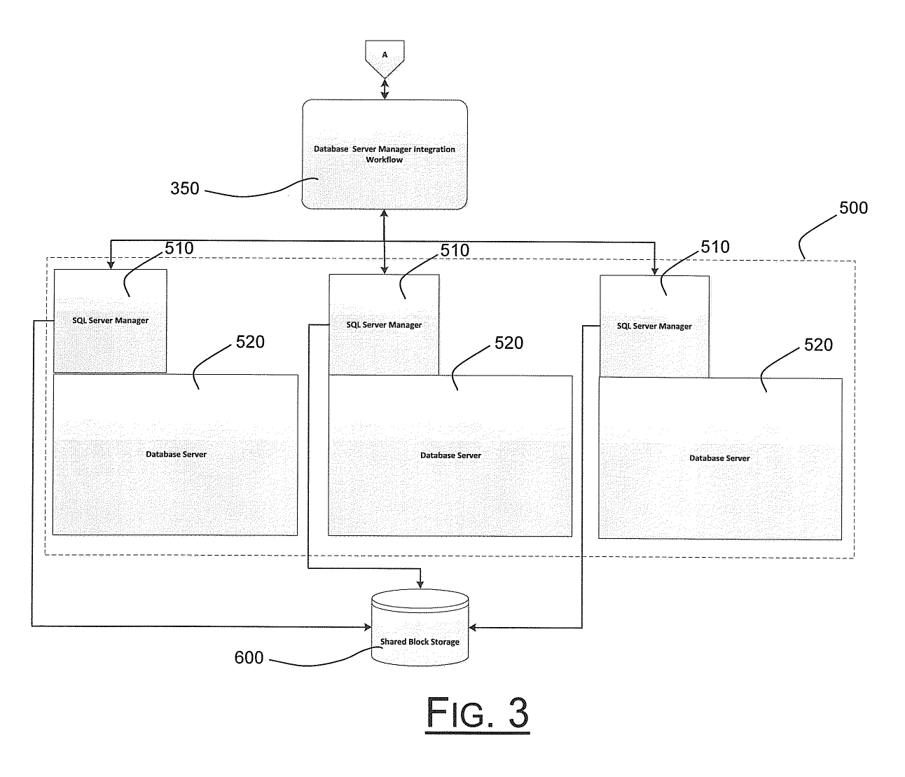

With the major components of the system described we turn now to FIGS. 2 and 3, which detail in more particularity the innovations of the present invention. All communication requests to and from the cloud platform 100 are translated and routed by the cloud platform workflow integration 200 to the Database as a Servers (DBaaS) Provisioning and Resource Rebalancing Automation 310 or workflow automation 400 as appropriate.

In the present embodiment, the DBaaS Provisioning and Resource Rebalancing Automation 310 is a Transact-SQL (T-SQL) Runbook that queries the DBaaS Provisioning and Resource Database 320 at certain polling intervals. The DBaaS Provisioning and Resource Rebalancing Automation 310 evaluates the level of resources and rebalances or provisions new database instances across the Database Servers and Optimization System 500 according to criteria as determined by the system operator.

Such criteria determined by the system operator could include the percentage of CPU, RAM, or disk storage usage. Other possible criteria could include any performance related factors as determined by the system operator such as time to perform one database calculation or query. Additional criteria could include the CPU or case temperatures, CPU or case fan speed, or power usage among others.

In an alternative embodiment the DBaaS Provisioning and Resource Rebalancing Automation 310 rebalances or provisions databases preferentially using performance history. In this alternative, the DBaaS Provisioning and Resource Rebalancing Automation 310 evaluates the highest performing database instances and balances those database instances across the Database Servers and Optimization System 500 to maximize the performance of said database instance. This performance history monitoring could also be assigned preferentially to certain database customers. Thus, in this alternative, a database customer who pays a premium could have their database instance preferentially balanced across highest performing instances in the Database Servers and Optimization System 500.

The DBaaS Provisioning and Resource Rebalancing Automation 310 obtains all of the information required to appropriate perform its functions from the DBaaS Provisioning and Resource Database 320. The DBaaS Provisioning and Resource Database 320 maintains a table of all databases and resources in the Database Servers and Optimization System 500 as well as for each individual database instance in the cluster. The DBaaS Provisioning and Resource Database 320 also monitors the current utilization of resources in the Database Servers and Optimization System 500 as a whole as well as for each individual database instance. Further, in one alternative embodiment the DBaaS Provisioning and Resource Database 320 maintains a performance history of all database instances it monitors.

The DBaaS Provisioning and Resource Database 320 maintains this data in accordance with system operator selected guidelines. The DBaaS Provisioning and Resource Database 320 supplies this data to any service or runbook that requests it using the appropriate protocols. The DBaaS Provisioning and Resource Database 320 is populated by the DBaaS P&R Database Population Automation 340. The DBaaS P&R Database Population Automation 340 is a T-SQL Runbook that obtains information regarding the status of each database instance in the Database Servers and Optimization System 500 from workflow automation 400.

In the present embodiment, the DBaaS Workflow Automation 330 is a T-SQL Runbook that that provides provisioning and rebalancing instructions to workflow automation 400 from the DBaaS Provisioning and Resource Rebalancing Automation 310.

Reference is now made to FIG. 3, which is a continuation of the systems and processes set forth on FIG. 2. In the present embodiment, the Database Server Manager Integration Workflow 350 is a T-SQL Runbook that queries the Database Servers and Optimization System 500 for information about the individual database servers' resources and utilization and commands rebalances as instructed. The Database Server Manager Integration Workflow 350 works as two components. One component acts as an interface to the workflow automation 400 and the second component acts as an interface to the SQL Server Manager 510. The Database Server Manager Integration Workflow 350 determines where to place databases amongst the various clusters. The SQL Server Manager 510 is paired to each Database Server 520 instance and manages clusters of virtualized and real SQL Servers and other resources in conjunction with a shared block storage 600 system. The SQL Server Manager 510 helps to determine database placement on the database server. Database servers natively lack the functionality provided by the SQL Server Manager 510. The SQL Server Manager 510 also provides quick database movement and propagation across database server instances. Multiple pairings of SQL Server Manager 510 and Database Server 520 constitutes the database cluster 500.

The Database Server 520 is a commercially available relational database server. Alternative embodiments of the present invention may substitute different relational database servers. In all embodiments, the Database Server 520 provides the core relational database services. Specifically those database services are the storing, retrieval, and manipulation of data as requested by other software applications. In some embodiments the Database Server 520 could be virtual, actual, or a mix of virtual and actual servers.

Together the DBaaS Provisioning and Resource Rebalancing Automation 310, DBaaS Provisioning and Resource Database 320, DBaaS Workflow Automation 330, and the DBaaS P&R Database Population Automation 340 and Database Server Manager Integration Workflow 350 function as an integration layer between workflow automation 400, Database Server 520, and any cloud IaaS platform. This provides the opportunity to implement MS SQL (the preferred embodiment) across many types of IaaS platforms as well as optimize the resources used by the databases. It further provides for quick horizontal scaling and management as well as propagation of new databases in a cloud environment, satisfying a long felt need in the art.

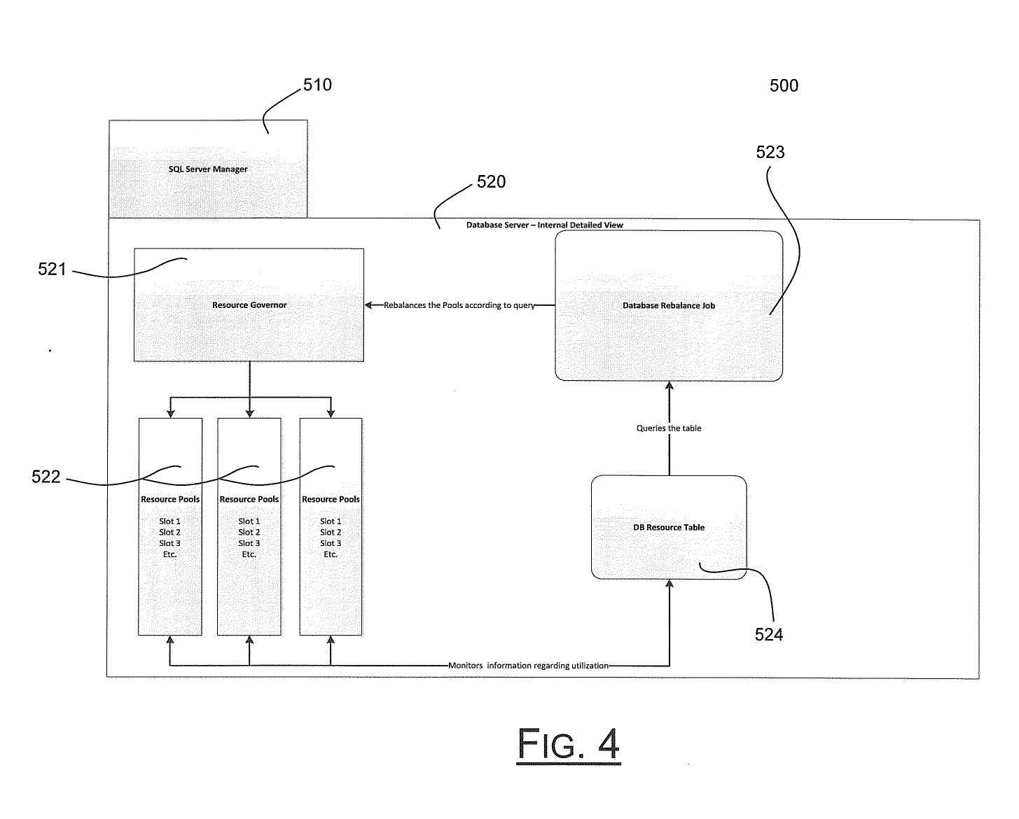

Reference is now made to FIG. 4, which describes various innovations internal to a Database Server 520. Each Database Server 520 may contain multiple databases. The resource governor 521 is a commercially available software component that monitors and allocates server resources among databases on that server. The resource governor 521 specifies limits on resource consumption by incoming requests. Server resources are further divided into various resource pools 522, which are then further sub-divided into various slots. Each resource pool 522 can have different performance characteristics. The DB Resource Table 524 monitors the utilization and performance characteristics of the resource pools 522. The Database Rebalance Job 523 is a series of T-SQL jobs that run on the database server that queries and updates the information in the DB Resource Table 524 as databases are created and deleted. This information is used by the resource governor 521 to rebalance the databases across the resource pools 522. In an alternative embodiment the DB Resource Table 524 tracks the performance history of the resource pools 522 and the Database Rebalance Job 523 directs the rebalancing based off of this performance history.

Together the innovations described by the present invention allow the integration of MS SQL and other databases into a cloud environment. These databases are then managed and rebalanced from the individual database level in the Database Server 520 up to the level of database clusters.

Alternative embodiments of certain aspects of the present invention also include adaptations of the methods and systems described above, such as adaptations to be used for providing a straightforward method and system by which a database software package can be adapted, integrated, and optimized for use on a cloud environment. It will be evident to those of skill in the art whether and how systems and methods of the present method can be adapted for use with any particular database software or cloud environment.

Specific details are given in the above description to provide a thorough understanding of various preferred embodiments. However, it is understood that these and other embodiments may be practiced without these specific details. For example, processes may be shown in block diagrams in order not to obscure the embodiments in unnecessary detail. In other instances, well-known processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have many additional steps not included in the figure. A process may correspond to a method, a function, a procedure, a subroutine, a subprogram, etc. When a process corresponds to a function, its termination corresponds to a return of the function to the calling function or the main function.

Embodiments of the invention may involve use middleware and/or other software implementation; the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may be downloadable through an internet connection service. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that contain or carry instruction(s) and/or data.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

While the principles of the disclosure have been described above in connection with specific apparatuses and methods, it is to be clearly understood that this description is made only by way of example and not as limitation on the scope of the disclosure. Whether now known or later discovered, there are countless other alternatives, variations and modifications of the many features of the various described and illustrated embodiments, both in the process and in the system characteristics, that will be evident to those of skill in the art after careful and discerning review of the foregoing descriptions, particularly if they are also able to review all of the various systems and methods that have been tried in the public domain or otherwise described in the prior art. All such alternatives, variations and modifications are contemplated to fall within the scope of the present invention.

Although the present invention has been described in terms of the foregoing preferred and alternative embodiments, these descriptions and embodiments have been provided by way of explanation of examples only, in order to facilitate understanding of the present invention. As such, the descriptions and embodiments are not to be construed as limiting the present invention, the scope of which is limited only by the claims of this and any related patent applications and any amendments thereto.

What is claimed is:

1. A method for optimizing the use of database servers in a multi-tenant environment, the method comprising:
a. polling a database cluster for performance information from each database server in said database cluster;
b. populating a resource database with said performance information;
c. querying said resource database at polling intervals;
d. determining whether any action should be taken based on said performance information; and
e. providing instructions regarding said action to said database cluster.

2. The method of claim 1, wherein said resource database also maintains information regarding the prior performance history from each database in said database cluster.

3. The method of claim 2, wherein said action is also determined based on said prior performance history.

4. The method of claim 3, wherein said action is also determined based on operator selected performance criteria.

5. A method for optimizing the use of a database within a database server, the method comprising the steps of:
a. polling said database server's resource governor for performance information from each database in said database server;
b. populating a resource database with said performance information;
c. querying said resource database at polling intervals;
d. determining whether any action should be taken based on said performance information; and
e. providing instructions regarding said action to said resource governor.

6. The method of claim 5, wherein said resource database also maintains information regarding the prior performance history from each database in said database cluster.

7. The method of claim 6, wherein said action is also determined based on said prior performance history.

8. The method of claim 7, wherein said action is also determined based operator selected performance criteria.

9. A system for quickly and transparently provisioning, horizontal scaling, and managing of a plurality of databases across a plurality of database servers comprising:
a. a database to receive performance information regarding the performance from a plurality of database servers in a multi-tenant environment;
b. a manager that reviews said performance information from said database, evaluates said performance information, initiates actions and sends said actions to a database server manager; and
c. a plurality of database servers, each having said database server manager to provide an interface among the said plurality of database servers and to send information and receive and act on instructions from said manager.

10. A system for quickly and transparently provisioning, horizontal scaling, and managing of a plurality of databases within a database server comprising:
a. a database to receive performance information regarding the performance from a plurality of databases within a database server; and
b. a manager that reviews said performance information from said database, evaluates said performance information, initiates actions optimizing said plurality of databases.
